(19) United States
(12) Patent Application Publication
(10) Pub. No.: US 2025/0353334 A1
(43) Pub. Date: Nov. 20, 2025

(54) TIRE

(71) Applicant: BRIDGESTONE CORPORATION, Chuo-ku, Tokyo (JP)

(72) Inventor: Hiroyuki KATSUNO, Chuo-ku, Tokyo (JP)

(73) Assignee: BRIDGESTONE CORPORATION, Chuo-ku, Tokyo (JP)

(21) Appl. No.: 18/871,811

(22) PCT Filed: May 26, 2023
(86) PCT No.: PCT/JP2023/019787

§ 371 Date: Dec. 5, 2024

(30) Foreign Application Priority Data
Jul. 7, 2022 (JP) 2022-110069

(51) Int. Cl. B60C 19/00

(52) U.S. Cl. CPC B60C 19/00; B60C 2019/004

(57) ABSTRACT

Provided is a tire 10 comprising a pair of bead portions, a carcass consisting of at least one carcass ply, a bead filler, and an electronic device 6 attached to a tire inner surface of a tire side portion consisting of the sidewall portion and the bead portion, wherein a nominal rim diameter of an applicable rim for the tire 10 is 20 inches or more, a carcass cord 411 of the carcass ply 41 is made of steel, the electronic device 6 is provided with an antenna 6b that extends in a direction that intersects an extending direction of the carcass cord 411 when viewed in a tire axial direction, and a number of intersections between the electronic device 6 including the antenna 6b and the carcass cord 411, when viewed in the tire axial direction, is 7 to 25.

### TECHNICAL FIELD

This disclosure relates to a tire.

This application claims priority to Patent Application No. 2022-110069, filed in Japan on Jul. 7, 2022, the entire contents of which are incorporated herein by reference.

### BACKGROUND

A configuration in which an electronic device such as an RF tag is attached to the inner surface of a tire has been known (For example, PTL 1).

### CITATION LIST

### Patent Literature

PTL 1: JP 2014-528873 A

### SUMMARY

### Technical Problem

However, especially when the tire size is large, due to the large thickness of the side rubber, there was the issue that it was difficult to obtain sufficient communication performance and durability of an electronic device when it was attached to the tire inner surface of the tire side portion which consists of the sidewall portion and the bead portion of the tire.

Therefore, an object of the present disclosure is to provide a tire that can improve the communication performance and durability of an electronic device attached to the tire inner surface of the tire side portion of a large-sized tire.

### Solution to Problem

The above problem can be solved by the following means.

(1) The tire of this disclosure is characterized in:
comprising a pair of bead portions having a bead core, a carcass consisting of at least one carcass ply that extends between the pair of bead portions via a pair of sidewall portions and a tread portion, a bead filler arranged adjacent to an outer side in the tire radial direction of the bead core, and an electronic device attached to a tire inner surface of a tire side portion consisting of the sidewall portion and the bead portion, wherein
a nominal rim diameter of an applicable rim for the tire is 20 inches or more,
a carcass cord of the carcass ply is made of steel,
the electronic device is provided with an antenna that extends in a direction that intersects an extending direction of the carcass cord when viewed in a tire axial direction, and
a number of intersections between the electronic device including the antenna and the carcass cord, when viewed in the tire axial direction, is 7 to 25.

### Advantageous Effect

According to the present disclosure, it is possible to provide a tire that can improve the communication performance and durability of an electronic device attached to the tire inner surface of the tire side portion of a large-sized tire.

### BRIEF DESCRIPTION OF THE DRAWINGS

In the accompanying drawings:

FIG. 1 is a schematic cross-sectional view in the tire width direction of a tire according to one embodiment of the present disclosure;

FIG. 2 is a plan view schematically illustrating an example of an electronic device that can be used in a tire according to one embodiment of the present disclosure;

FIG. 3 is a schematic drawing to explain the arrangement relationship of the electronic device and the carcass cords in the tire illustrated in FIG. 1;

FIG. 4 is a schematic partial cross-sectional view in the tire width direction to explain the arrangement position of an electronic device in an example according to one embodiment of the present disclosure; and

FIG. 5 is a schematic partial cross-sectional view in the tire width direction to explain the arrangement position of an electronic device in another example according to one embodiment of the present disclosure.

### DETAILED DESCRIPTION

The tire according to this disclosure can be used well as, for example, an OR tire (tire for construction and mining vehicles).

Hereinafter, embodiments of a tire according to the present disclosure will be described with reference to the drawings.

The same components and parts are designated by the same reference numerals/symbols in each drawing.

As used herein, the term “tire circumferential direction” refers to the direction in which the tire rotates around its rotation axis (axis line), the term “tire radial direction” refers to the direction that is perpendicular to the rotation axis of the tire, and the term “tire width direction” refers to the direction that is parallel to the rotation axis of the tire. In some drawings, the tire circumferential direction is indicated by the symbol “CD”, the tire radial direction is indicated by the symbol “RD”, and the tire width direction is indicated by the symbol “WD”.

In addition, as used herein, the side that is closer to the rotation axis of the tire along the tire radial direction is referred to as the “inner side in the tire radial direction”, and the side that is farther from the rotation axis of the tire along the tire radial direction is referred to as the “outer side in the tire radial direction”.

In addition, as used herein, the side that is closer to the tire equatorial plane CL along the tire width direction is referred to as the “inner side in the tire width direction”, and the side that is further from the tire equatorial plane CL along the tire width direction is referred to as the “outer side in the tire width direction”.

Further, as used herein, the phrase “extending in the tire circumferential direction” means extending with at least a tire circumferential component. That is, the phrase “extending in the tire circumferential direction” means that it may extend in a direction that follows the tire circumferential direction (i.e. at an angle of 0° to the tire circumferential direction, without inclining with respect to the tire circumferential direction), or it may extend at an angle other than 90° to the tire circumferential direction (i.e. at an inclination angle of more than 0° and less than 90° with respect to the tire circumferential direction).

Furthermore, as used herein, the phrase “extending in the tire width direction” means extending with at least a tire widthwise component. That is, the phrase “extending in the tire width direction” means that it may extend in a direction that follows the tire width direction (i.e. at an angle of 0° to the tire width direction, without inclining with respect to the tire width direction), or it may extend at an angle other than 90° to the tire width direction (i.e. at an inclination angle of more than 0° and less than 90° with respect to the tire width direction).

Unless otherwise specified, the position and dimensions of each element shall be measured under the reference conditions where the tire is mounted on the applicable rim, filled with the prescribed internal pressure, and unloaded. In addition, the term “tread surface” refers to the outer surface around the entire circumference of the tire that is in contact with the road surface when the tire is mounted on the applicable rim, filled with the prescribed internal pressure, and rolled under a maximum load, and the edges in the tire width direction of the tread surface are referred to as the “tread edges”.

As used herein, the term “applicable rim” refers to the standard rim in the applicable size (Measuring Rim in ETRTO's STANDARDS MANUAL and Design Rim in TRA's YEAR BOOK) as described or as may be described in the future in the industrial standard, which is valid for the area in which the tire is produced and used, such as JATMA YEAR BOOK of JATMA (Japan Automobile Tyre Manufacturers Association) in Japan, STANDARDS MANUAL of ETRTO (The European Tyre and Rim Technical Organization) in Europe, and YEAR BOOK of TRA (The Tire and Rim Association, Inc.) in the United States. For sizes not listed in these industrial standards, the term “applicable rim” refers to a rim with a width corresponding to the bead width of the pneumatic tire. The “applicable rim” includes current sizes as well as future sizes to be listed in the aforementioned industrial standards. An example of the “sizes as described in the future” could be the sizes listed as “FUTURE DEVELOPMENTS” in the ETRTO 2013 edition.

As used herein, the term “prescribed internal pressure” refers to the air pressure (maximum air pressure) corresponding to the maximum load capacity of a single wheel in the applicable size and ply rating, as described in the aforementioned JATMA YEAR BOOK and other industrial standards. In the case that the size is not listed in the aforementioned industrial standards, the term “prescribed internal pressure” refers to the air pressure (maximum air pressure) corresponding to the maximum load capacity specified for each vehicle in which the tire is mounted. Further, as used herein, the term “maximum load” means the load corresponding to the maximum load capacity in the tire of the applicable size described in the aforementioned industrial standards, or, for sizes not listed in the aforementioned industrial standards, the load corresponding to the maximum load capacity specified for each vehicle in which the tire is mounted.

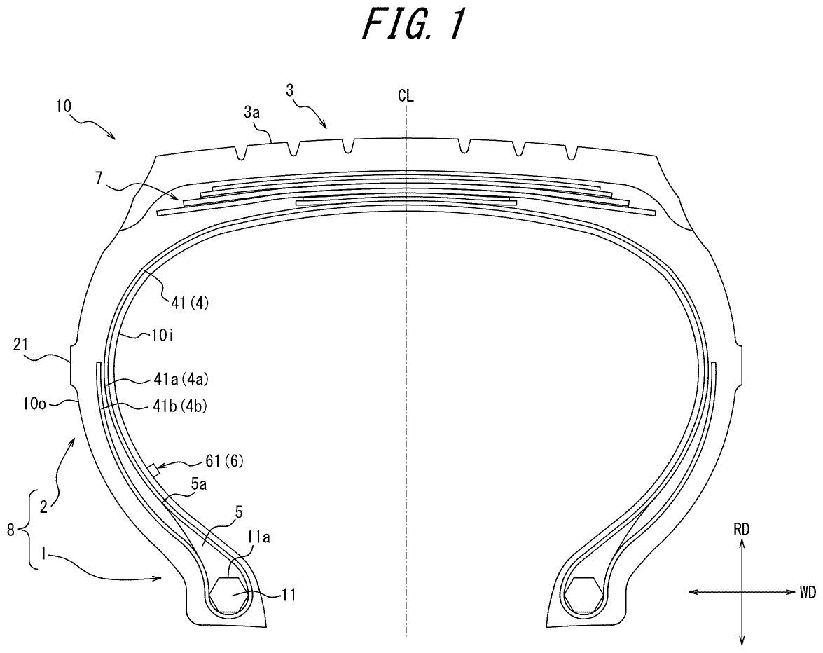

FIG. 1 is a drawing to explain a tire 10 according to one embodiment of the present disclosure, and is a schematic cross-sectional view in the tire width direction of the tire 10.

It will be noted that the tire 10 according to the embodiment of this disclosure may be configured as any type of tire as long as the nominal rim diameter of the applicable rim is 20 inches or more.

As used herein, the term “nominal rim diameter of applicable rim” (hereinafter, simply referred to as “nominal rim diameter”) refers to the inner diameter of the tire, and thus the rim diameter of the applicable rim mentioned above. More specifically, the term refers to the designation (in inches) of the rim diameter of the applicable rim, which is generally indicated in the tire size displayed on the sidewall portion of the tire, in other words, to the rim diameter of the applicable rim expressed in inches. For example, if the tire size is “29.5R25”, the nominal rim diameter is “25 inches”, if the tire size is “18.00R33”, the nominal rim diameter is “33 inches”, if the tire size is “46/90R57”, the nominal rim diameter is “57 inches”, and if the tire size is “59/80R63”, the nominal rim diameter is “63 inches”.

As illustrated in FIG. 1, the tire 10 according to this embodiment has a bead portion 1, a sidewall portion 2, and a tread portion 3. The bead portion 1 is a portion that is configured to come into contact with a rim on its inner side in the tire radial direction and on its outer side in the tire width direction when the tire 10 is mounted on a rim. The tread portion 3 is a portion of the tire 10 that extends in the tire width direction between a pair of tread edges. The sidewall portion 2 is a portion that extends between the pair of bead portions 1 and the tread portion 3. In this document, the sidewall portion 2 and the bead portion 1 are sometimes collectively referred to as a tire side portion 8. The above-mentioned sidewall portion 2 refers to the portion that extends to the inner side in the tire radial direction than at least a belt 7 mentioned below and to the outer side in the tire radial direction than the bead portion 1.

More specifically, the tire 10 of this embodiment comprises: a pair of bead portions 1 having a bead core 11, a carcass 4 consisting of at least one carcass ply 41 that extends between the pair of bead portions 1 via the pair of sidewall portions and the tread portion, a bead filler 5 arranged adjacent to the outer side in the tire radial direction of the bead core 11, and an electronic device 6 attached to a tire inner surface 10i of the tire side portion 8 consisting of the sidewall portion 2 and the bead portion 1.

In this embodiment, the tire 10 has the pair of bead portions 1. Each of the pair of bead portions 1 has a bead core 11. Each of the bead cores 11 is embedded in the corresponding bead portion 1. The bead core 11 may include a plurality of bead wires that are surrounded by a rubber coating. However, the bead core 11 may consist of a single bead wire. The bead wire is preferably made of metal (e.g. steel). For example, the bead wire may be, for example, formed of monofilament or stranded wire. In addition, the bead wire may be made of organic fibers or carbon fibers, etc.

In this example, as illustrated in FIG. 1, the cross-sectional shape of the bead core 11 in the tire width direction is a regular hexagon, however, the cross-sectional shape of the bead core 11 may be another shape, such as a polygonal shape other than a regular hexagon or a circular shape.

In this embodiment, the tire 10 has the carcass 4 consisting of at least one carcass ply 41. The at least one carcass ply 41, and thus the carcass 4 extends between the pair of bead portions 1 via the pair of sidewall portions 2 and the tread portion 3. More specifically, the carcass ply 41, and thus the carcass 4 extends in a toroidal shape from one bead portion 1 to the other bead portion 1 via one sidewall portion 2, the tread portion 3, and the other sidewall portion 2.

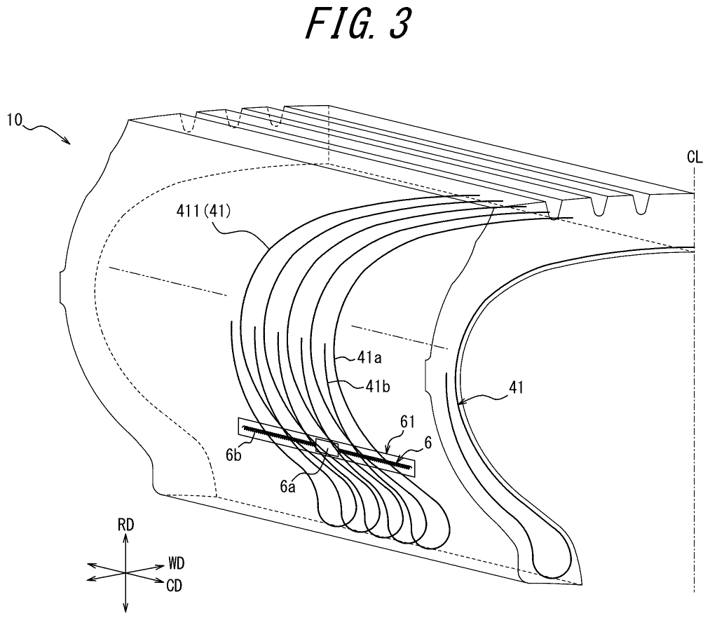

In the present example, as illustrated in FIGS. 1 and 3, the carcass ply 41 (and thus, the carcass 4) comprises a ply body portion 41a (and thus, a carcass body portion 4a) located between the bead cores 11 of the pair of bead portions 1, and ply turn-up portions 41b (and thus, carcass turn-up portions 4b) folded from the inner side to the outer side in the tire width direction around each bead core 11 from both ends of the ply body portion 41a (carcass body portion 4a). However, the carcass ply 41 (carcass 4) does not have to comprise the ply turn-up portions 41b (carcass turn-up portions 4b).

In this example, as illustrated in FIG. 1, the carcass 4 is composed of a single carcass ply 41. However, the carcass 4 may be composed of a plurality of carcass plies 41.

Each carcass ply 41 contains one or more carcass cords 411 (see FIG. 3) and a coating rubber that covers the carcass cords 411. The carcass cord 411 may be formed of monofilament or stranded wire, for example.

In this embodiment, the carcass cord 411 of the carcass ply 41 is made of steel. To be more specific, each of the plurality of carcass cords 411 contained in each carcass ply 41 is made of steel.

In addition, in this embodiment, the carcass 4 has a radial structure. In other words, as illustrated in FIG. 3, each carcass cord 411 included in the carcass 4 extends substantially along the tire width direction (i.e., in a projection view from the outer side in the tire radial direction of the tread portion 3, at an angle of substantially 0°, without inclining, with respect to the tire width direction).

In this embodiment, the tire 10 has the bead filler 5. As illustrated in FIG. 1, the bead filler 5 is arranged adjacent to the outer side in the tire radial direction of the bead core 11. In other words, as illustrated in FIGS. 1, 4 and 5, the bead filler 5 is in contact with the outer portion in the tire radial direction of each corresponding bead core 11, and extends from the upper end 11a of the each bead core 11 toward the outer side in the tire radial direction to the upper end 5a of the bead filler 5. In each of the examples in FIGS. 1, 4 and 5, the bead filler 5 extends in a tapering shape toward the outer side in the tire radial direction. The bead filler 5 is made of hard rubber, for example.

It will be noted that, as in the example in FIG. 1, there may be cases where a plurality of (for example, two) rubber members of different materials with different hardness are arranged in layers along the tire radial direction, for example, on the outer side in the tire radial direction of the bead core 11 (in particular, between the carcass body portion 4a and the carcass turn-up portion 4b, for example, on the outer side in the tire radial direction of the bead core 11). However, in this document, the term “bead filler” refers to a single rubber member that is arranged adjacent to (i.e., in contact with) the outer side in the tire radial direction of the bead core 11.

In this embodiment, the tire 10 has the electronic device 6.

As used herein, the term “electronic device” refers to a device that comprises electronic components and has communication functions with the outside world.

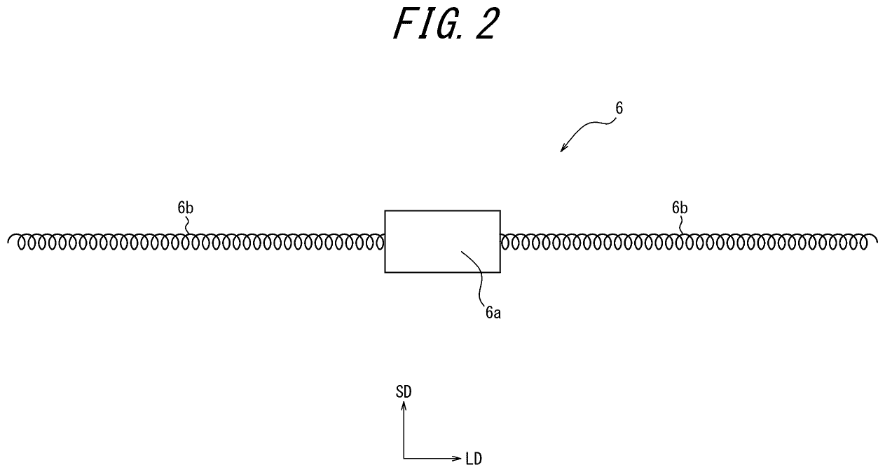

FIG. 2 is a plan view schematically illustrating an example of an electronic device that can be used in a tire according to one embodiment of the present disclosure.

In the example in FIG. 2, the electronic device 6 is an RF tag that has an IC chip 6a with a storage section, etc., and one or more (in the illustrated example, two) antennas 6b that transmit and/or receive electromagnetic waves. The RF tag is also commonly referred to as an RFID (Radio Frequency Identification) tag.

In this example, the antennas 6b are connected to the IC chip 6a and extends in a straight line, a wave-like shape, or a spiral shape (in the illustrated example, a spiral shape). In this example, two antennas 6b extend from the IC chip 6a in opposite directions. However, the antennas 6b may extend from the IC chip 6a in only one direction. In addition, in this example, the two antennas 6b have the same length along the long side direction LD of the IC chip 6a, which will be described later. However, the two antennas 6b may have different lengths along the long side direction LD of the IC chip 6a.

In this example, the IC chip 6a has a thin plate shape with a generally rectangular shape in a plan view. Here, the “thickness” of the IC chip 6a refers to the thickness in the direction perpendicular to both of: the direction, in a plan view, parallel to the long side of the IC chip 6a (hereafter, also referred to as the “long side direction of the IC chip (6a)”) LD; and the direction, in a plan view, parallel to the short side of the IC chip 6a (hereafter, also referred to as the “short side direction of IC chip (6a)”) SD. The IC chip 6a has, for example, a storage section that is any known memory and a controller that is any known processor. The IC chip 6a may operate by the induced electromotive force generated by the electromagnetic waves received by the one or more antennas 6b. In other words, the electronic device 6 may be a passive communication device. Alternatively, the electronic device 6 may be further provided with a battery and be able to generate electromagnetic waves and communicate using its own power. In other words, the electronic device 6 may be an active communication device. The controller of the IC chip 6a can, for example, read data such as production management, shipping management, and usage history management of the tire stored in the storage section, or write these data to the storage section.

In this embodiment, as illustrated in FIGS. 1 and 3, the electronic device 6 (e.g., an RF tag) is attached to the tire inner surface 10i of the tire side portion 8 consisting of the sidewall portion 2 and the bead portion 1. In this document, the term “tire inner surface” refers to the surface of the tire that faces the inner cavity of the tire.

The electronic device 6 may be attached to the tire inner surface 10i of the tire side portion 8 in the state of the electronic device 6 itself, which comprises the IC chip 6a and the antennas 6b as illustrated in FIG. 2, for example. Alternately, the electronic device 6 may be attached to the tire inner surface 10i of the tire side portion 8 as an electronic device laminate 61 in which the IC chip 6a of the electronic device 6 is covered on both sides in the thickness direction with thin sheet-like coating rubber. Alternately, the electronic device 6 may be attached to the tire inner surface 10i of the tire side portion 8 as an electronic device laminate 61 in which one side (the bottom side) of the IC chip 6a of the electronic device 6 is covered with thin sheet-like coating rubber and the other side (the top side) is covered with slightly thicker patch rubber. The electronic device 6 or the electronic device laminate 61, which contains the electronic device 6, may be attached to the tire inner surface 10i using an adhesive cement, for example.

It will be noted that, in FIG. 1, the electronic device laminate 61, which contains the electronic device 6, is illustrated in a simplified form, however in this embodiment, the electronic device 6 is attached to the tire inner surface 10i so that the top and bottom surfaces (front and back surfaces) of the thin sheet-like IC chip 6a are along with the tire inner surface 10i (i.e., in a way that the two surfaces are almost parallel), with the bottom side of the IC chip 6a facing the tire inner surface 10i.

In addition, in this embodiment, the tire inner surface 10i of the tire 10 is composed of an inner liner (not illustrated in particular) with low permeability to air and/or gas. In this case, the electronic device 6 is attached to the surface of the inner liner on the lumen side of the tire.

In the example illustrated in FIG. 1, the tire 10 further comprises the belt 7 consisting of at least one layer (in the illustrated example, six layers) of belt layers in the tread portion 3. The belt 7 is arranged on the outer side in the tire radial direction of the crown portion of the carcass 4. Each belt layer contains one or more belt cords and a coating rubber that covers the belt cords. The belt cord can be formed of monofilament or stranded wire, for example. The belt cord may be made of metal (e.g. steel) or organic fibers such as polyester, nylon, rayon, or aramid.

In addition, in the illustrated example, tread rubber that forms a tread surface 3a is provided on the outer side in the tire radial direction of the belt 7 in the tread portion 3. A tread pattern is formed on the tread surface 3a. The tread pattern is not particularly limited.

Furthermore, in the illustrated example, side rubber that forms an outer surface 10o of the tire side portion 8 is formed on the outer side in the tire width direction of the carcass 4 in the tire side portion 8. In addition, in the illustrated example, a protrusion 21, which is generally referred to as a “decoline”, protruding flatly toward the outside of the tire 10 and extending in a ring shape in the tire circumferential direction at a tire radial position including the tire maximum width position of the tire 10, is formed in the sidewall portion 2 in order to improve the appearance of the tire 10, improve cut resistance, and protect the carcass 4, etc.

In this embodiment, the nominal rim diameter of an applicable rim for the tire 10 is 20 inches or more. In other words, the tire 10 in this embodiment is a large-sized, large-scale tire.

It will be noted that when the nominal rim diameter for the tire 10 is 20 inches or more, from the perspective of ensuring sufficient strength in the vicinity of the bead portion 1, it is preferable that the maximum width of the area in which the bead filler 5 exists (hereinafter, also referred to as the “bead filler area”) excluding the electronic device 6 (hereinafter, also referred to as the “maximum width of the bead filler area”) is preferably 30 mm or more. Here, in this document, the above-mentioned “bead filler area” more specifically refers to the area extending from the tire inner surface 10i to the tire outer surface 10o, where the bead filler 5 is present, when viewed in the direction perpendicular to the tire inner surface 10i in the cross-sectional view in the tire width direction. In addition, the “maximum width of the bead filler area” mentioned above shall refer to the maximum width when the width of the bead filler area is measured in the direction perpendicular to the tire inner surface 10i in the cross-sectional view in the tire width direction.

The following explains the relationship between the electronic device 6 attached to the tire inner surface 10i and the components inside the tire, as well as the more specific positioning thereof, etc., in this embodiment.

FIG. 3 is a schematic drawing to explain the arrangement relationship of the electronic device 6 and the carcass cords 411 in the tire 10 illustrated in FIG. 1. FIG. 3 is a schematic drawing for explanation, and is a schematic perspective view of the half tire seen from the outside, including a partial cross-section in the tire width direction. In FIG. 3, the carcass ply 41 and the carcass cords 411 inside the tire 10, as well as the electronic device laminate 61, which includes the electronic device 6, attached to the tire inner surface 10i of the tire 10, are not normally visible from the outside of the tire, however, are illustrated in solid lines for ease of understanding. In addition, in FIG. 3, the bead core 11, the bead filler 5, the belt 7, etc., illustrated in the example in FIG. 1, are omitted for ease of understanding. Furthermore, in FIG. 3, not all of the carcass cords 411, which are arranged at intervals in the tire circumferential direction, are illustrated, and some of them are omitted. In addition, the antennas 6b of the electronic device 6 may be extended in a spiral shape as an example (see FIG. 2), however in FIG. 3, the antennas 6b are drawn in a simplified manner so that these extend in a straight line as a whole.

In this embodiment, as illustrated in FIG. 3, the antenna 6b of the electronic device 6 extends in a direction that intersects the extending direction of the carcass cord 411 when viewed in the tire axial direction. In other words, the electronic device 6 is provided with the antenna 6b that extends in a direction that intersects the extending direction of the carcass cord 411 when viewed in the tire axial direction. Here, in this document, the phrase “when viewed in the tire axial direction” means that: when the tire side is projected in the tire width direction (parallel to the rotation axis (axis line) of the tire) WD from the outside of the tire 10, it is viewed in that direction.

When viewed in the tire axial direction, the antenna 6b only needs to extend in a direction that intersects with the extending direction of the steel carcass cord 411, that is, it only needs not to extend in a direction that is along the extending direction of the carcass cord 411 (that is, at an angle of 0°, without being inclined, with respect to the extending direction). However, from the perspective of making the carcass cord 411 more effectively exhibit the antenna effect, which is obtained by the cooperation with the antenna 6b, described below, it is preferable that the antenna 6b extends, when viewed in the tire axial direction, at an angle of 45 to 90° with respect to the extending direction of the carcass cord 411, more preferable that it extends at an angle of 80 to 90°, and most preferable that it extends at an angle of 90°.

In the examples illustrated in FIGS. 1 and 3, the carcass 4 has a radial structure, i.e., when viewed in the tire axial direction, the carcass cord 411 extends at an angle of substantially 90° with respect to the tire circumferential direction CD. In this case, it is preferable, when viewed in the tire axial direction, that the antenna 6b extends at an angle of 0 to 45° with respect to the tire circumferential direction CD, more preferable that it extends at an angle of 0 to 10°, and most preferable that it extends along the tire circumferential direction CD (at an angle of 0°, without being inclined, with respect to the tire circumferential direction CD).

It will be noted that, in the above, the extending direction of the antenna 6b shall be taken to mean the direction in which the antenna 6b extends as a whole. For example, in the example in FIG. 2, the extending direction of the antenna 6b refers to the direction in which the line segment connecting the two ends, in the long side direction of the IC chip 6a, of at least one antenna 6b extends.

In addition, if the carcass ply 41 includes the ply body portion 41a and the ply turn-up portion 41b, as in the examples in FIGS. 1 and 3, and/or if the carcass 4 includes a plurality of carcass plies 41, the carcass cord 411 that should be considered in relation to the above-mentioned relationship with the antenna 6b is the carcass cord 411 of the carcass ply 41 or the carcass cord 411 of the part of the carcass ply 41 (the ply body portion 41a or the ply turn-up portion 41b) that is closest to the tire inner surface 10i. For example, in the examples illustrated in FIGS. 1 and 3, the carcass cord 411 that should be considered in the above relationship with the antenna 6b is the carcass cord 411 in the ply body portion 41a of the single carcass ply 41. This is because the carcass cord 411 closest to the antenna 6b of the electronic device 6 attached to the tire inner surface 10i is most likely to exhibit the antenna effect, which is obtained in cooperation with the antenna 6b, described below.

In this embodiment, the number of intersections between the electronic device 6 including the antenna 6b and the carcass cord 411, when viewed in the tire axial direction, is 7 to 25.

Here, if the carcass ply 41 includes the ply body portion 41a and the ply turn-up portion 41b, as in the examples in FIGS. 1 and 3, and/or if the carcass 4 includes a plurality of carcass plies 41, the carcass cord 411 that should be considered in relation to the above-mentioned relationship with the electronic device 6 including the antenna 6b is, same as above, the carcass cord 411 of the carcass ply 41 or the carcass cord 411 of the part of the carcass ply 41 (the ply body portion 41a or the ply turn-up portion 41b) that is closest to the tire inner surface 10i. For example, in the examples illustrated in FIGS. 1 and 3, the carcass cord 411 that should be considered in the above relationship with the electronic device 6 including the antenna 6b is the carcass cord 411 in the ply body portion 41a of the single carcass ply 41. Also, the number of intersections mentioned above refers to the number of crossings between one electronic device 6 and the carcass cord 411. Furthermore, in the above, the phrase “electronic device 6 including the antenna 6b” is intended to mean that the crossing between the carcass cord 411 and the entire electronic device 6, including not only the antenna 6b of the electronic device 6 but also the antenna 6b and IC chip 6a, etc., is taken into account.

In the example in FIG. 3, the number of intersections between the electronic device 6 including the antenna 6b and the carcass cord 411 is only illustrated as 5 in the figure, but it is actually 8 to 10.

Next, the effects of the above-mentioned embodiment will be described.

First, in this embodiment, the electronic device 6 is attached to the tire inner surface 10i of the tire side portion 8. This prevents the electronic device 6 from breaking down due to contact with foreign objects on the outside of the tire 10, and ensures the basic durability of the electronic device 6.

Next, in this embodiment, the carcass cord 411 of the carcass ply 41 is made of steel. This makes it possible to achieve sufficient strength even with a simple radial structure for the carcass, for example, in a large-sized tire having a nominal rim diameter of 20 inches or more, such as the tire 10 of the present embodiment. At the same time, this allows the carcass cord 411 to have an antenna effect (antenna function) that works with the antenna 6b of the electronic device 6 under certain conditions. Furthermore, even if the tire is large in size and has a large maximum width of the bead filler area, etc., it will be possible to enhance the communication ability of the electronic device 6 attached to the tire inner surface 10i under certain conditions. It will be noted that even if the antenna 6b of the electronic device 6 does not come into direct contact with the steel carcass cord 411, the carcass cord 411 can still exert the above-mentioned antenna effect.

In addition, in this embodiment, the electronic device 6 is provided with the antenna 6b that extends in a direction that intersects the extending direction of the carcass cord 411 when viewed in a tire axial direction. This allows the carcass cord 411 to exhibit the above-mentioned antenna effect, which in turn improves the communication performance of the electronic device 6.

In addition, in this embodiment, the number of intersections between the electronic device 6 including the antenna 6b and the carcass cord 411, when viewed in the tire axial direction, is 7 to 25. This allows the carcass cord 411 to exhibit sufficient antenna effects, and thus, even with large-sized tires, it is possible to improve the communication performance of the electronic device 6, as well as improve the durability of the electronic device 6. In the case of large-sized tires, if the number of the intersections is less than 7, it will not be possible to sufficiently improve the communication performance of the electronic device 6, and if the number of the intersections exceeds 25, the length of the antenna 6b of the electronic device 6 will become too long, and it will not be possible to sufficiently ensure the durability of the electronic device 6. The reason why the durability of the electronic device 6 cannot be sufficiently secured when the length of the antenna 6b is too long is that when the tire is stepped on and kicked off while traveling, the tire is easily affected by shear strain (which is particularly large around the tire maximum width position) that causes deformation forward and backward in the direction of travel when viewed in the tire axial direction, and the electronic device 6 is easily damaged.

As described above, according to the tire 10 of the present embodiment, it is possible to improve the communication performance and durability of the electronic device 6 attached to the tire inner surface 10i of the tire side portion 8 of a large-sized tire 10.

The following describes the suitable configuration (in particular, the more suitable arrangement position of the electronic device 6 in the tire 10) and examples of modifications, etc., of the tire 10 of this embodiment.

Even among the large-sized tires with a nominal rim diameter of 20 inches or more, the internal dimensions of the tire, especially the bead filler height BH, etc., described below, differ greatly depending on the size of the tire. Therefore, in the following, the size (nominal rim diameter) will be explained separately for two sizes.

### <When the Nominal Rim Diameter is 20 to 57 Inches>

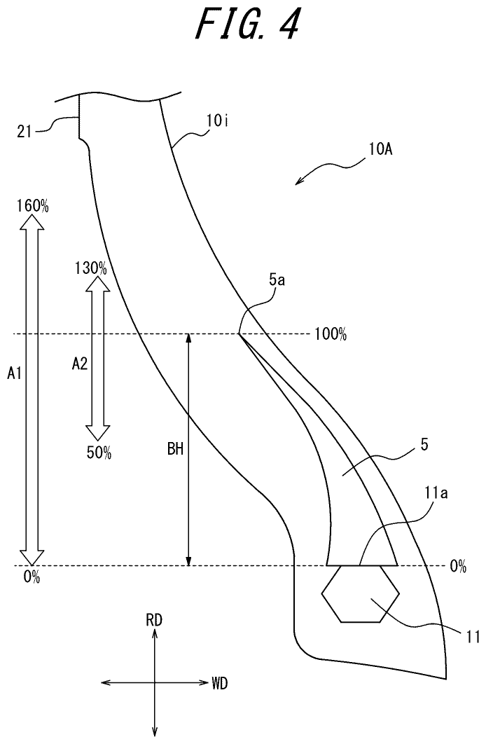

FIG. 4 is a schematic partial cross-sectional view in the tire width direction to explain the arrangement position of the electronic device 6 (see FIG. 1) in the tire 10A in one example according to one embodiment of the present disclosure. More specifically, FIG. 4 is a schematic cross-sectional view of the tire 10A, with a nominal rim diameter of 20 to 57 inches or more (also referred to as a “first-size tire”), from the sidewall portion to the bead portion. For the purposes of explanation, the shape of the bead filler 5 is simplified, and the carcass 4 (see FIG. 1) is not illustrated. The configuration of the first-size tire 10A other than its size (nominal rim diameter) is basically the same as the tire 10 described above. In other words, the first-size tire 10A is one type of the tire 10 described above. Therefore, in the following description, the reference numerals and symbols used in FIGS. 1 to 3 will also be used where appropriate.

In the case of the first-size tire 10A, that is, when the nominal rim diameter for the tire 10 is 20 to 57 inches, the maximum width of the bead filler area is preferably 30 mm or more from the perspective of ensuring sufficient strength in the vicinity of the bead portion 1, and 80 mm or less from the perspective of avoiding increases in tire weight, etc.

Examples of nominal rim diameters of applicable rims for the first-size tire 10A include 25 inches, 29 inches, 33 inches, 35 inches, 49 inches, 51 inches, and 57 inches, etc.

In the first-size tire 10A (that is, the nominal rim diameter for the tire 10 is 20 to 57 inches), it is preferable that the electronic device 6 (see FIG. 1) is arranged at the position where its tire radial distance from an upper end 11a of the bead core 11 is 0 to 160% of a tire radial height BH of the bead filler 5 (Hereafter, also referred to simply as “bead filler height”.) from the upper end 11a of the bead core 11 (in other words, within the tire radial region A1 illustrated in FIG. 4), and it is more preferable to be arranged in a position that is 50% to 130% (in other words, within the tire radial region A2 illustrated in FIG. 4). Here, for example, the phrase “a position where its tire radial distance from an upper end 11a of the bead core 11 is 0 to 160% of a tire radial height BH of the bead filler 5 from the upper end 11a of the bead core 11” refers, more specifically, to the tire radial position between: the tire radial position where its tire radial distance from the upper end 11a of the bead core 11 is 0% of the bead filler height BH, and the tire radial position that is on the outer side in the tire radial direction than the above tire radial position, and where its tire radial distance from the upper end 11a of the bead core 11 is 160% of the bead filler height BH.

By arranging the electronic device 6 at the position where its tire radial distance from the upper end 11a of the bead core 11 is 0% or more of the bead filler height BH, it is possible to reduce the influence from the rim flange of the rim to which the tire is mounted and the bead core 11, and thus further improving the communication performance of the electronic device 6 in the first-size tire 10A. At the same time, by arranging the electronic device 6 at the position where its tire radial distance from the upper end 11a of the bead core 11 is 160% or less of the bead filler height BH, it is possible to reduce the influence of the shear strain that occurs, especially largely around the tire maximum width position, when the tire is stepped on and kicked off while traveling, and thus further improving the durability of electronic device 6 in the first-size tire 10A. For the same reason, by arranging the electronic device 6 at the position where its above-mentioned tire radial distance is 50% or more and 160% or less, the communication performance and durability of the electronic device 6 in the first-size tire 10A can be further improved.

It will be noted that, in this document, when it is said that the electronic device 6 is “arranged in a certain position”, unless otherwise specified, it means that at least the center of the longitudinal direction of the electronic device 6, including the antenna 6b, is arranged in that position.

Here, the inventor examined how the above shear strain value and the communication performance of the electronic device 6 would change depending on the tire radial distance thereof from the upper end 11a of the bead core 11 (Positions on the outer side in the tire radial direction from the upper end 11a are indicated as +, and positions on the inner side in the tire radial direction from the upper end 11a are indicated as -.) for the first-size tire 10A (as an example, a tire with size of 40.00R57) in order to find the suitable tire radial position on the tire where the electronic device 6 should be attached. The shear strain values were calculated using FEM simulations. In addition, regarding the communication performance of the electronic device 6, the tester measured the communication range of the electronic device 6 by determining how far away from the electronic device 6 the data stored in the electronic device 6 could be read by the data reader.

As a result, it was found that the shear strain value becomes sufficiently small when the above-mentioned tire radial distance is 160% or less of the bead filler height BH, and becomes even more sufficiently small when it is 130% or less. In addition, regarding the communication performance of the electronic device 6, when the above-mentioned tire radial distance was 0% or more of the bead filler height BH, it was possible to read the data sufficiently even when the electronic device 6 was about 0.5 m away, and when the distance was 50% or more, it was possible to read the data sufficiently even when the electronic device 6 was about 1 m away. This results also indicate that it is suitable to arrange the electronic device 6 in the above-mentioned tire radial position as described above for the first-size tires 10A.

Furthermore, based on the same simulation and its result, the second-size tire 10B which will be discussed later, has also been observed the same trend as above, regarding the tire radial position of the electronic device 6 which is considered to be suitable for the second-size tire 10B described below.

In the first-size tire 10A (that is, the nominal rim diameter for the tire 10 is 20 to 57 inches), it is preferable that the number of intersections between the electronic device 6 including the antenna 6b and the carcass cord 411, when viewed in the tire axial direction, is 9 to 25.

In this case, from the same perspective as mentioned above regarding the number of intersections, the communication performance and the durability of the electronic device 6 can be further improved for the first-size tire 10A.

<When the Nominal Rim Diameter is Larger than 57 Inches>

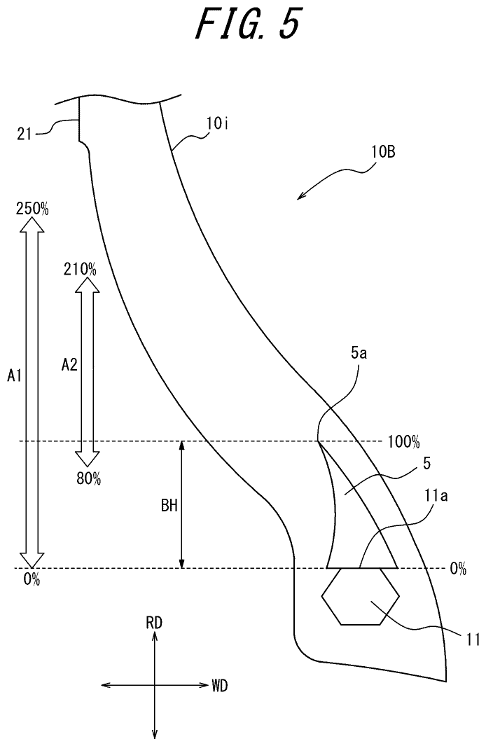

FIG. 5 is a schematic partial cross-sectional view in the tire width direction to explain the arrangement position of the electronic device 6 (See FIG. 1) on the tire 10B in another example according to one embodiment of the present disclosure. More specifically, FIG. 5 is a schematic cross-sectional view of the tire 10B, with a nominal rim diameter of larger than 57 inches (also referred to as a “second-size tire”), from the sidewall portion to the bead portion. For the purposes of explanation, the shape of the bead filler 5 is simplified, and the carcass 4 (see FIG. 1) is not illustrated. As with the first-size tire 10A mentioned above, the configuration of the second-size tire 10B other than its size (nominal rim diameter) is also basically the same as the tire 10 described above. In other words, the second-size tire 10B is one type of the tire 10 described above. Therefore, in the following description, the reference numerals and symbols used in FIGS. 1 to 3 will also be used where appropriate.

In the case of the second-size tire 10B, that is, when the nominal rim diameter for the tire 10 is larger than 57 inches, the maximum width of the bead filler area is preferably larger than 80 mm from the perspective of ensuring sufficient strength in the vicinity of the bead portion 1, and 140 mm or less from the perspective of avoiding increases in tire weight, etc.

Examples of nominal rim diameters of applicable rims for the second-size tire 10B include 63 inches, etc.

In the second-size tire 10B (that is, the nominal rim diameter for the tire 10 is larger than 57 inches), it is preferable that the electronic device 6 (see FIG. 1) is arranged at the position where its distance in the tire radial direction from an upper end 11a of the bead core 11 is 0 to 250% of the tire radial height BH of the bead filler 5 from the upper end 11a of the bead core 11 (in other words, within the tire radial region A1 illustrated in FIG. 5), and it is more preferable to be arranged in a position that is 80% to 210% (in other words, within the tire radial region A2 illustrated in FIG. 5).

By arranging the electronic device 6 at the position where its tire radial distance from the upper end 11a of the bead core 11 is 0% or more of the bead filler height BH, it is possible to reduce the influence from the rim flange of the rim to which the tire is mounted and the bead core 11, and thus further improving the communication performance of the electronic device 6 in the second-size tire 10B. At the same time, by arranging the electronic device 6 at the position where its tire radial distance from the upper end 11a of the bead core 11 is 250% or less of the bead filler height BH, it is possible to reduce the influence of the shear strain that occurs, especially largely around the tire maximum width position, when the tire is stepped on and kicked off while traveling, and thus further improving the durability of electronic device 6 in the second-size tire 10B. For the same reason, by arranging the electronic device 6 at the position where its above-mentioned tire radial distance is 80% or more and 210% or less, the communication performance and durability of the electronic device 6 in the second-size tire 10B can be further improved.

In the second-size tire 10A (that is, the nominal rim diameter for the tire 10 is larger than 57 inches), it is preferable that the number of intersections between the electronic device 6 including the antenna 6b and the carcass cord 411, when viewed in the tire axial direction, is 7 to 8.

In this case, from the same perspective as mentioned above regarding the number of intersections, the communication performance and the durability of the electronic device 6 can be further improved for the second-size tire 10B.

In this embodiment, a plurality of electronic devices 6 with the same arrangement and configuration as the electronic devices 6 in the above examples may be attached to the tire inner surface 10i at different positions around the circumference of the tire. In addition, in this embodiment, a plurality of electronic devices may be attached to the tire inner surface 10i at different positions around the circumference of the tire, for example, with at least one electronic device having the same arrangement and configuration as the electronic device 6 in each of the above examples, and at least one electronic device having a different arrangement or configuration than the electronic device 6 in each of the above examples.

In these cases, one or more of the electronic devices are arranged in one half of the tire in the tire width direction, with the tire equatorial plane CL as the boundary, and one or more of the electronic devices are arranged in the other half of the tire in the tire width direction, with the tire equatorial plane CL as the boundary. It is preferable that the plurality of electronic devices are arranged so that, when viewed in the tire axial direction, they are separated from each other by at least 45° in the tire circumferential direction, with the center of the rotation axis (axis line) of the tire as the center. In this case, even if a failure or detachment occurs in at least one of the plurality of electronic devices, there is a high possibility that one of the other electronic devices will remain functional, and thus, it can prevent electronic devices from being unable to read or write information on the tire 10, for example.

In the above case, it is preferable that the plurality of electronic devices are arranged at equal intervals in the tire circumferential direction. This arrangement makes it possible to even out the impact of events that can cause a failure or detachment of the electronic devices while traveling of the vehicles, and to ensure that one of the electronic devices will remain functional. In the context of the phrase “arranged at equal intervals in the tire circumferential direction”, the electronic devices may be arranged at equal intervals in either or both of the respective halves of the tire in the tire width direction without considering which half of the tire the electronic devices are located in; or the electronic devices may be arranged at equal intervals when viewed in the tire axial direction, with both of the halves of the tire in the tire width direction combined.

In addition, in the above case, it is preferable that the electronic devices arranged in one half of the tire in the tire width direction and the electronic devices arranged in the other half of the tire in the tire width direction are arranged alternately in the tire circumferential direction. According to this arrangement, if an event that causes a failure occurs in one electronic device, the other electronic device, which is adjacent to the one electronic device in the tire circumferential direction, is located in a different half of the tire in the tire width direction to the half of the tire where the one electronic device located in, so that to avoid as much as possible the effects of events that could cause a failure in the other electronic device.

Furthermore, in the above case, it is preferable that the number of electronic devices arranged in one half of the tire in the tire width direction is the same as the number of electronic devices arranged in the other half of the tire in the tire width direction. In this case, the impact of the event causing the failure can be further even out.

The above description is an example of an exemplary embodiment of the present disclosure, and various changes can be made without departing from the scope of the claims.

For example, in addition to the electronic device 6 of the above-mentioned arrangement and configuration attached to the tire inner surface 10i of the tire 10, as described above, at least one electronic device of the same or different configuration as the electronic device 6 may be attached to a location other than the tire inner surface 10i of the tire.

### INDUSTRIAL APPLICABILITY

The tire according to this disclosure can be used well as, for example, an OR tire (tire for construction and mining vehicles).

### REFERENCE SIGNS LIST

1 Bead portion
11 Bead core
11a Upper end of bead core
2 Sidewall portion
21 Protrusion
3 Tread portion
3a Tread surface
4 Carcass
4a Carcass body portion
4b Carcass turn-up portion
41 Carcass ply
41a Ply body portion
41b Ply turn-up portion
411 Carcass cord
5 Bead filler
5a Upper end of bead filler
6 Electronic device
6a IC chip
6b Antenna
61 Electronic device laminate
7 Belt
8 Tire side portion
10 Tire
10A Tire (first-size tire)
10B Tire (second-size tire)
10i Tire inner surface
100 Tire outer surface
A1, A2 Tire radial region
BH Bead filler height
CD Tire circumferential direction
CL Tire equatorial plane
LD Long side direction
RD Tire radial direction
SD Short side direction
WD Tire width direction

1. A tire comprising a pair of bead portions having a bead core, a carcass consisting of at least one carcass ply that extends between the pair of bead portions via a pair of sidewall portions and a tread portion, a bead filler arranged adjacent to an outer side in the tire radial direction of the bead core, and an electronic device attached to a tire inner surface of a tire side portion consisting of the sidewall portion and the bead portion, wherein
a nominal rim diameter of an applicable rim for the tire is 20 inches or more,
a carcass cord of the carcass ply is made of steel,
the electronic device is provided with an antenna that extends in a direction that intersects an extending direction of the carcass cord when viewed in a tire axial direction, and
a number of intersections between the electronic device including the antenna and the carcass cord, when viewed in the tire axial direction, is 7 to 25.

2. The tire according to claim 1, wherein a nominal rim diameter of an applicable rim for the tire is 20 to 57 inches, and
the electronic device is arranged at a position where its tire radial distance from an upper end of the bead core is 0 to 160% of a tire radial height of the bead filler from the upper end of the bead core.

3. The tire according to claim 2, wherein the electronic device is arranged at a position where its tire radial distance from an upper end of the bead core is 50 to 130% of a tire radial height of the bead filler from the upper end of the bead core.

4. The tire according to claim 2, wherein the number of intersections between the electronic device including the antenna and the carcass cord, when viewed in the tire axial direction, is 9 to 25.

5. The tire according to claim 1, wherein a nominal rim diameter of an applicable rim for the tire is larger than 57 inches, and
the electronic device is arranged at a position where its tire radial distance from an upper end of the bead core is 0 to 250% of a tire radial height of the bead filler from the upper end of the bead core.

6. The tire according to claim 5, wherein the electronic device is arranged at a position where its tire radial distance from an upper end of the bead core is 80 to 210% of a tire radial height of the bead filler from the upper end of the bead core.

7. The tire according to claim 5, wherein the number of intersections between the electronic device including the antenna and the carcass cord, when viewed in the tire axial direction, is 7 to 8.

8. The tire according to claim 3, wherein the number of intersections between the electronic device including the antenna and the carcass cord, when viewed in the tire axial direction, is 9 to 25.

9. The tire according to claim 6, wherein the number of intersections between the electronic device including the antenna and the carcass cord, when viewed in the tire axial direction, is 7 to 8.
